(19) United States
(12) Patent Application Publication
(10) Pub. No.: US 2014/0175979 A1
(43) Pub. Date: Jun. 26, 2014

(54) LIGHT EMITTING PLASMA LIGHTING APPARATUS HAVING RF SHIELDING BAFFLES

(71) Applicant: Stray Light Optical Technologies, (US)

(72) Inventors: Gerald W. Rea, Scottsburg, IN (US); Robert A. Drake, Nashville, IN (US)

(21) Appl. No.: 13/829,131

(22) Filed: Mar. 14, 2013

Related U.S. Application Data
(60) Provisional application No. 61/644,786, filed on May 9, 2012.

(51) Int. Cl. H01J 61/02

(52) U.S. Cl. CPC H01J 61/025
USPC 315/85

(57) ABSTRACT

A light emitting plasma lighting apparatus includes at least one conductive RF shielding baffle located in a reflector housing between an emitter and a window. The at least one RF shielding baffle includes a planar body portion aligned generally perpendicular to an outer surface of the plasma bulb to minimize interference with light emitted from the plasma bulb. The at least one RF shielding baffle is grounded to absorb a portion of an RF field emitted by the emitter.

### CROSS REFERENCE TO RELATED APPLICATION

This application claims the benefit of U.S. Application Ser. No. 61/644,786, filed on May 9, 2012, which is expressly incorporated herein by reference.

### BACKGROUND AND SUMMARY OF THE DISCLOSURE

The present disclosure relates to a lighting apparatus. More particularly, the present disclosure relates to an energy efficient light emitting plasma lighting apparatus having a compact design, effective heat management characteristics, and a reduced level of radio frequency (RF) emissions.

Light emitting plasma (LEP) lights which produce energy efficient, high intensity output light are well known. Typically, a LEP lighting apparatus emits a full-spectrum white light which can be rapidly dimmed to about twenty percent (20%) of its light output.

An illustrated LEP lighting apparatus includes an emitter having a quartz lamp embedded in a ceramic resonator or puck. A RF generator and microcontroller provide a RF driver which is connected to the emitter. The RF signal generated by the driver is coupled to the puck by a coaxial cable. The puck concentrates the RF field delivering energy to the sealed quartz lamp without the use of electrodes or filaments. The highly concentrated RF field ionizes the gases and vaporizes halides within the quartz lamp, thereby creating a plasma state at its center, resulting in an intense source of white light.

A LEP lighting apparatus emits an RF field in addition to the white light. Conventional LEP lights use a grounded conductive material such as a mesh, screen, film or coating covering a window of a reflector housing containing the plasma bulb to reduce the RF field emitted by the light. However, such conductive material covering the entire window of the reflector housing reduces the intensity of light emitted by the LEP lighting apparatus by about 15-20%.

The LEP lighting apparatus of the present disclosure does not use a conductive material covering the entire window in order to reduce the emitted RF field to an acceptable level. In certain illustrated embodiments of the present disclosure, the conductive material on the window is eliminated. In other embodiments, a conductive material such as a screen, mesh, coating or film covers less than the entire window to increase the amount of light emitted from lighting apparatus. In a further embodiment, the entire window is fully covered with a conductive material. However, the conductive material has a higher light transmission factor than conductive material used in conventional plasma lights without the RF shielding baffles of the present disclosure. Therefore, the embodiments of the present disclose achieve similar RF shielding with a higher light output than is achieved through the use of the lower light transmission RF shielding mesh alone.

In one illustrated embodiment of the present disclosure, a light emitting plasma lighting apparatus is driven by a driver which generates a radio frequency (RF) output signal. The light emitting plasma lighting apparatus includes a reflector housing having first and second openings, and an emitter including a body portion coupled to the first opening of the reflector housing. The body portion of the emitter has an opening therein. The emitter also includes a puck located in the opening of the body portion. The puck has an exposed bottom surface and a plasma bulb coupled to the bottom surface of the puck. The puck is coupled to the driver to receive the RF output signal and provide a concentrated RF field so that light is emitted from an outer surface of the plasma bulb and an RF field is emitted from the bottom surface of the puck. The light emitting plasma lighting apparatus also includes a reflector located in the reflector housing to direct light emitted from the plasma bulb through the second opening, a window positioned over the second opening of the reflector housing spaced apart from the plasma bulb so that light emitted from the plasma bulb passes through the window, and at least one conductive RF shielding baffle located in the reflector housing between the emitter and the window. The at least one RF shielding baffle includes a planar body portion aligned generally perpendicular to the outer surface of the plasma bulb to minimize interference with light emitted from the plasma bulb. The at least on RF shielding baffle is grounded to absorb a portion of the RF field emitted by puck.

In one illustrated embodiment, a plurality of RF shielding baffles are coupled to the body portion of the emitter. The planar body portion of each of the plurality of RF shielding baffles being aligned generally perpendicular to the outer surface of the plasma bulb.

In another illustrated embodiment, the at least one conductive RF shielding baffle is coupled to the reflector. For example, first and second RF shielding baffles are coupled to the reflector with planar body portions of the first and second RF shielding baffles aligned perpendicular to the bottom surface of the puck. Illustratively, the first and second RF shielding baffles intersect at a point aligned with the plasma bulb.

In yet another illustrated embodiment, a plurality of inner baffles are coupled to the first and second RF shielding baffles. The plurality of inner baffles each include a planar body portion aligned generally perpendicular to the outer surface of the plasma bulb.

In a further illustrated embodiment of the present disclosure, a light emitting plasma emitter apparatus includes a metal body portion defining an opening therein, and a puck located in the opening of the body portion. The puck has an exposed bottom surface and a plasma bulb coupled to the bottom surface of the puck. The puck is configured to provide a concentrated RF field from a RF signal received from a driver so that light is emitted from an outer surface of the plasma bulb and an RF field is emitted from the bottom surface of the puck. The light emitting plasma emitter apparatus also includes and at least one conductive RF shielding baffle coupled to the body portion over the bottom surface of the puck. The RF shielding baffle includes a planar body portion aligned generally perpendicular to the outer surface of the plasma bulb. The RF shielding baffle is grounded to absorb a portion of the RF field emitted from the bottom surface of the puck.

In another illustrated embodiment of the present disclosure, a light emitting plasma lighting apparatus is driven by a driver which generates a radio frequency (RF) output signal. The light emitting plasma lighting apparatus includes a reflector housing having first and second openings, and an emitter coupled to the first opening of the reflector housing. The emitter includes a puck having a bottom surface and a plasma bulb coupled to the bottom surface of the puck. The puck is coupled to the driver to receive the RF output signal so that light emitted from an outer surface of the plasma bulb and an RF field is emitted from the puck. The light emitting plasma lighting apparatus also includes a reflector located in the reflector housing to direct light emitted by the plasma bulb through the second opening, a window positioned over the second opening of the reflector housing spaced apart from the plasma bulb so that light emitted by the plasma bulb passes through the window, and at least one conductive portion covering at least one selected portion of the window. The at least one selected portion has a combined area less than an overall area of the window. The at least one conductive portion is grounded to absorb portions of the RF field emitted by the puck.

Additional features and advantages of the present disclosure will become apparent to those skilled in the art upon consideration of the following detailed description of illustrative embodiments exemplifying the best mode of carrying out the invention as presently perceived.

### BRIEF DESCRIPTION OF THE DRAWINGS

Features and advantages of this disclosure, and the manner of attaining them, will become more apparent and the invention itself will be better understood by reference to the following description of certain embodiments of the invention taken in conjunction with the accompanying drawings, wherein:

FIG. 1 is a block diagram illustrating an exemplary light emitting plasma (LEP) lighting apparatus of the present disclosure;

FIG. 2 is a bottom, perspective view illustrating one embodiment of an exemplary lighting apparatus of the present disclosure;

FIG. 3 is a perspective view illustrating an emitter of FIG. 2 and a plurality of radio frequency (RF) shielding baffles coupled to the emitter;

FIG. 4 is a plan view of a bottom surface of the emitter of FIG. 3 illustrating further details of the plurality of baffles situated around a bulb of the emitter;

FIG. 5 is a side view of the emitter of FIGS. 3 and 4;

FIG. 6 is a side view of the emitter of FIG. 5;

FIG. 7 illustrates details of one of the plurality of baffles of FIGS. 3-6;

FIGS. 8 and 9 illustrate a mounting bracket for securing the plurality of baffles to the emitter;

FIG. 10 is a bottom perspective view illustrating another embodiment of an exemplary lighting apparatus of the present disclosure;

FIG. 11 is a perspective view of an emitter and reflector of the embodiment of FIG. 10, the reflector including a plurality of RF shielding baffles;

FIG. 12 is a side view of the emitter and reflector of FIG. 11;

FIG. 13 is a bottom plan view of the emitter and reflector of FIG. 12 illustrating further details of the plurality of baffles situated around a bulb of the emitter;

FIGS. 14 and 15 illustrate one of the outer panels of the reflector of FIGS. 10-12;

FIGS. 16 and 17 illustrate inner RF shielding baffles of the reflector of FIGS. 10-12;

FIG. 18 is a bottom perspective view illustrating yet another embodiment of an exemplary lighting apparatus of the present disclosure;

FIG. 19 illustrates an additional inner RF baffle used in the embodiment of FIG. 18; and

FIG. 20 is a plan view of a bottom of a reflector housing including a conductive material covering portions of a window of the reflector housing.

Corresponding reference characters indicate corresponding parts throughout the several views. The drawings set out herein illustrate exemplary embodiments of the invention and such drawings are not to be construed as limiting the scope of the invention in any manner.

### DETAILED DESCRIPTION OF THE DRAWINGS

For the purposes of promoting an understanding of the principles of the present disclosure, reference will now be made to the embodiments illustrated in the drawings, which are described below. The embodiments disclosed below are not intended to be exhaustive or limit the present lighting system to the precise form disclosed in the following detailed description. Rather, the embodiments are chosen and described so that others skilled in the art may utilize their teachings. Therefore, no limitation of the scope of the lighting system is intended. The present lighting system includes any alterations and further modifications of the illustrated devices, systems and described methods and further applications of the principles of the present disclosure which would normally occur to one skilled in the art.

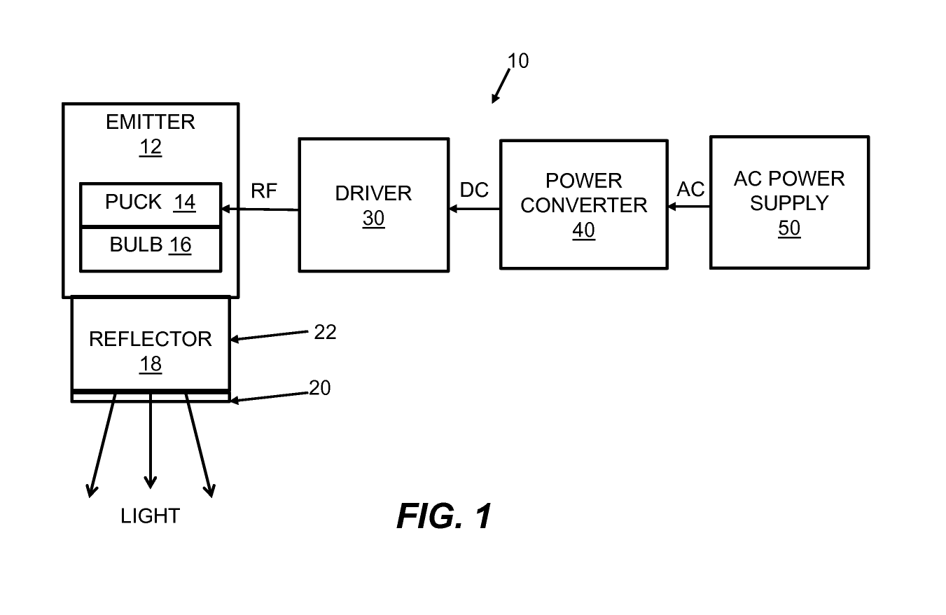

In an illustrated embodiment of the present disclosure, FIG. 1 illustrates an exemplary light emitting plasma (LEP) lighting apparatus 10. The lighting apparatus 10 includes an emitter 12 which receives a radio frequency (RF) signal from a power amplifier or driver 30. Driver 30 includes a microcontroller and a RF generator. The RF signal from driver 30 is input into a ceramic resonator or puck 14 having a cylindrically shaped, sealed quartz bulb 16. The puck 14 driven by the driver 30 creates a standing wave confined within its walls. An electric field of the standing wave is strongest at the center of the bulb 16 resulting in the ionization of the gasses inside the bulb 16. The ionized gas vaporizes contents of the bulb 16 into a plasma state at the center of bulb 16 to generate an intense source of light. Light is emitted from an outer surface of bulb 16 radially in all directions. As shown in FIG. 1, the light emitted by bulb 16 is directed by a reflector 18. Reflector 18 includes a window 20 is coupled to an opening of a reflector housing 22. Window 20 is made from glass or other suitable material which allows light to pass therethrough.

An exemplary emitter is model number STA 41-02 LEP emitter available from Luxim® located in Sunnyvale, Calif. Additional details regarding various components of lighting apparatus 10 are described in PCT International Publication No. WO/2012/031287, entitled LIGHTING APPARATUS, the disclosure of which is expressly incorporated by reference herein.

Driver 30 receives DC power from a power source or power converter 40. Power converter 40 receives AC power from an AC power supply 50, such as the grid, and rectifies the AC power to produce a DC power signal output from power converter 40.

Reflector 18 alters the direction of the light exiting bulb 16 to shape a desired illumination pattern on a spaced apart object. Exemplary spaced apart objects include the ground, floors, desktops, and other surfaces to be illuminated.

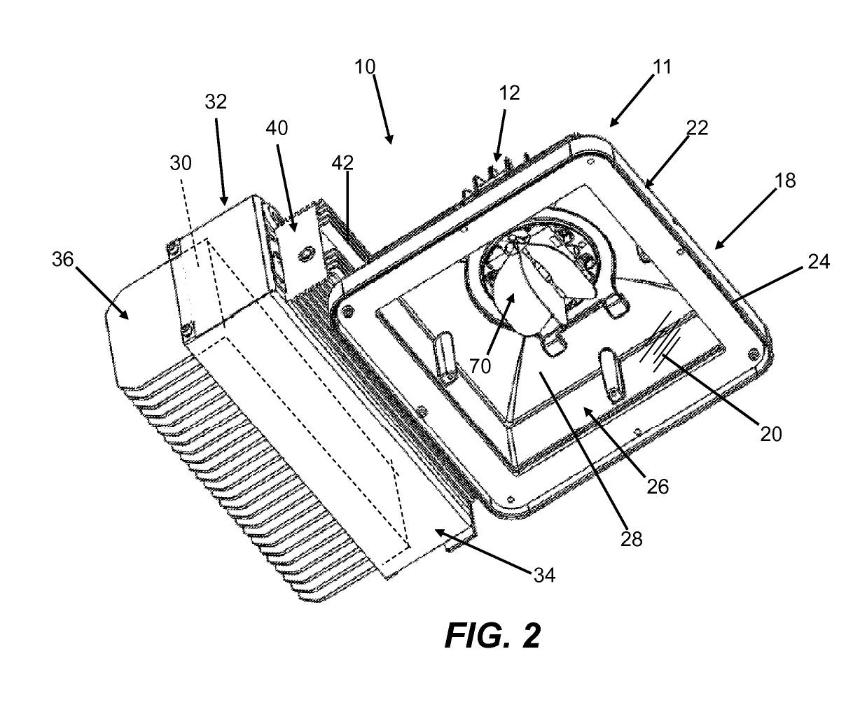

As best shown in FIG. 2, the driver 30 is part of a driver assembly 32. More particularly, the driver 30 is mounted in a driver housing 34. A heat sink block 36 is mounted to a side of driver housing 34 adjacent driver 30. Heat sink block 36 includes a body portion and a plurality of heat sink fins extending away from the body portion to dissipate heat from the driver 30. The driver 30 is illustratively coupled to the body portion of heat sink block 66 by suitable fasteners.

Power converter 40 including a plurality of heat sink fins 42 is mounted to an opposite side of driver housing 34 from driver 30 by suitable fasteners. Power converter 40 is illustratively an Inventronics Model EUV300S028ST. The power converter 40 is illustratively an IP67 (Ingess Protection) rated, 300 W, 28V constant voltage supply, although any suitable power supply may be used. Inventronics is located in Hangzhou, China.

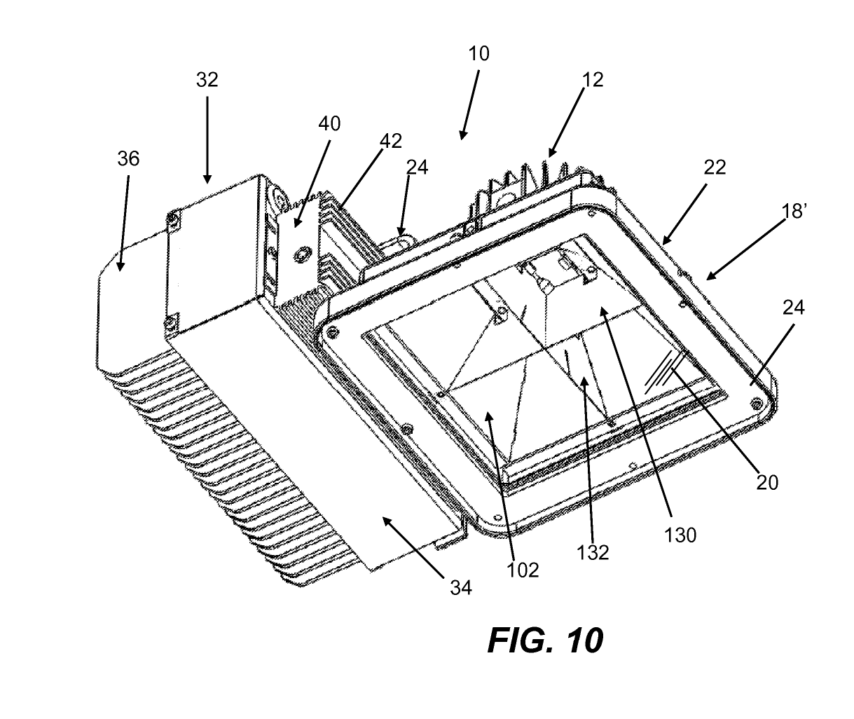

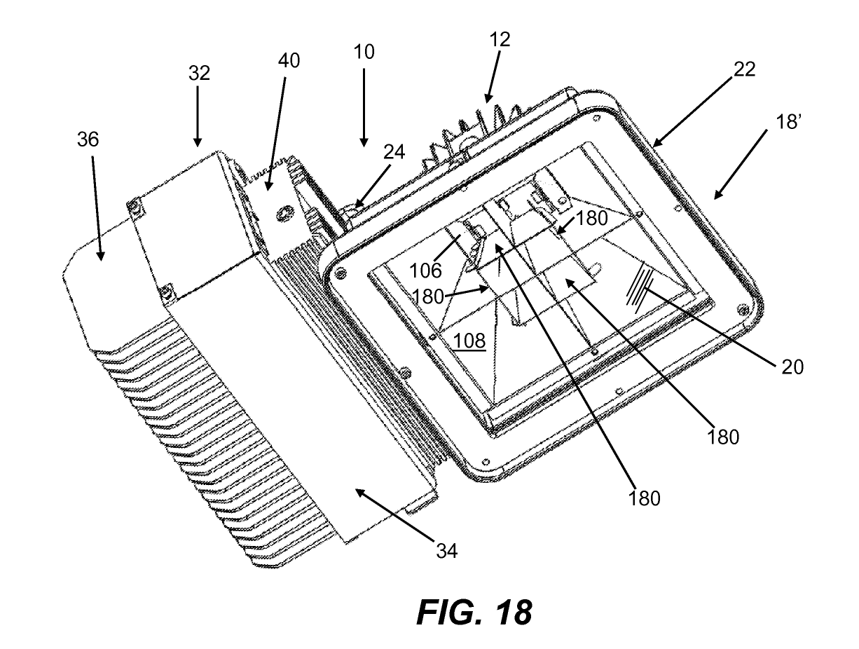

An emitter assembly 11 is pivotably coupled to the driver housing 34 by a suitable hinge connection 24 (see FIGS. 10 and 18) so that the emitter assembly 11 is moveable relative to the driver housing 34. As discussed above, the emitter assembly 11 includes an emitter 12 coupled to an opening in a top surface of reflector housing 22. Reflector housing 22 includes a bottom portion 24 defining an opening 26 spaced apart from the emitter 12. Window 20 is located over the opening 26. Reflector 18 includes an inner surface 28 which reflects light from the bulb 16 in a desired pattern from the reflector 18.

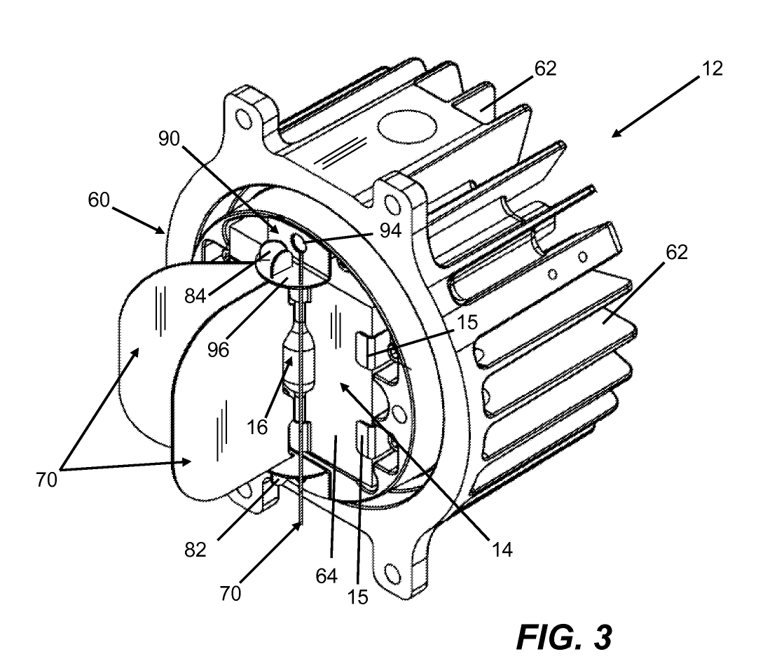

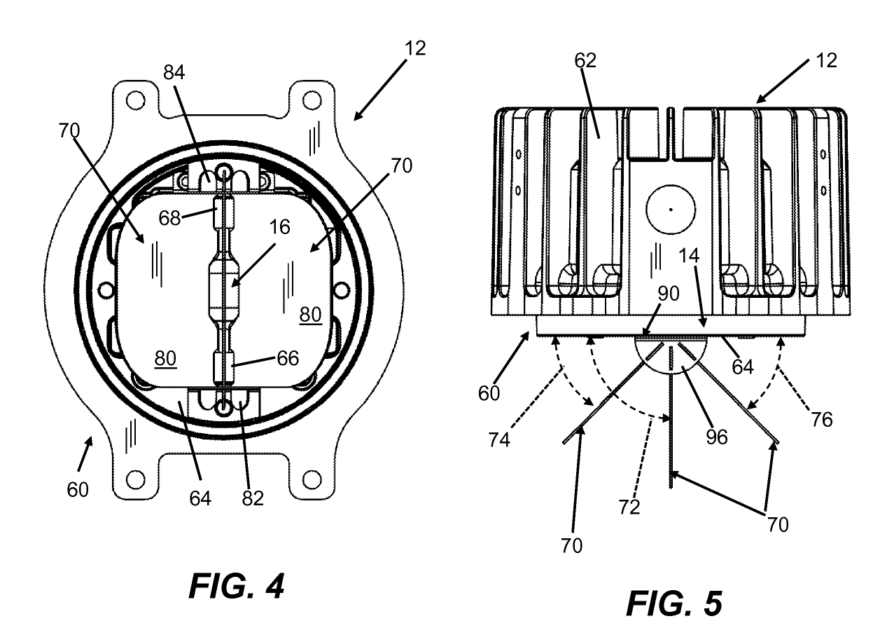

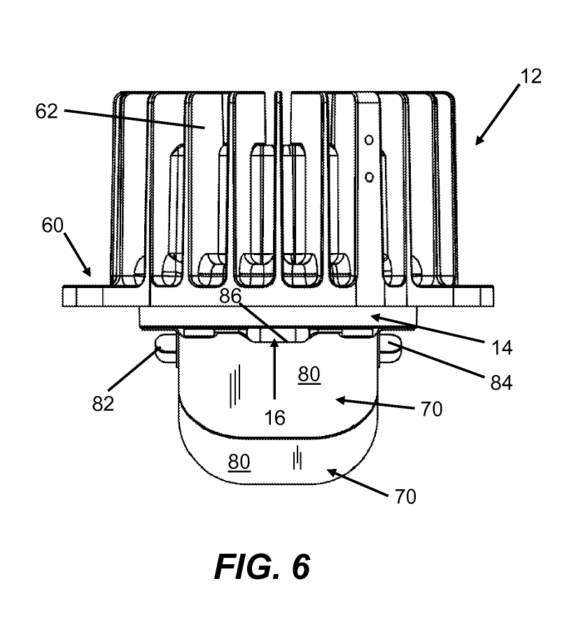

As best shown in FIGS. 3-6, the emitter 12 includes a body portion 60 having a plurality of heat sink fins 62 used to dissipate heat from the emitter 12. The puck 14 is located within the body portion 60 and is held in position with retainer clips 15 as best shown in FIG. 3. The bulb 16 is located on the bottom surface 64 of puck 14. Bulb 16 is held on puck 14 by first and second coupling portions 66 and 68.

As discussed above, the emitter 12 emits light from bulb 16 and a RF field from bottom surface 64 of puck 14. The RF field emitted by puck 14 in other directions is substantially blocked by the metal body portion 60 of emitter 12. Conventional LEP lights use a conductive material such as a screen, mesh, coating or film covering the entire window 20 to absorb the RF field so that RF interference emitted by the LEP light is reduced. However, use of such a conductive material covering window 20 also reduces or occludes the light output from the lighting apparatus by about 15-20%.

The LEP lighting apparatus 10 of the present disclosure does not use a conductive material covering the entire window 20 in order to reduce the emitted RF field to an acceptable level. In certain illustrated embodiments of the present disclosure, the conductive material on the window 20 is eliminated. In other embodiments, a conductive material such as a screen, mesh, coating or film covers less than the entire window 20 to increase the amount of light emitted from lighting apparatus 10.

An illustrated embodiment of FIGS. 2-9 includes a plurality of planar RF shielding baffles 70 coupled to the body portion 60 of emitter 12 above the bottom surface 64 of puck 14. In an illustrated embodiment, a center baffle 70 is positioned at a 90° angle relative to the bottom surface 64 of puck 14 as shown by angle 72 in FIG. 5. Side baffles 70 are illustratively positioned at a 45° angle relative to the bottom surface 64 of puck 14 as shown by angles 74 and 76 of FIG. 5. The baffles 70 are oriented generally perpendicular to an outer surface of bulb 16 to minimize the light blocking effect of baffles 70 on light emitted by bulb 16. In other words, planar body portions 74 of baffles 70 are located in a plan extending radially away from bulb 16. The term “generally perpendicular” as used here means 80°-100°, preferably 85°-95°, and most preferably 90°.

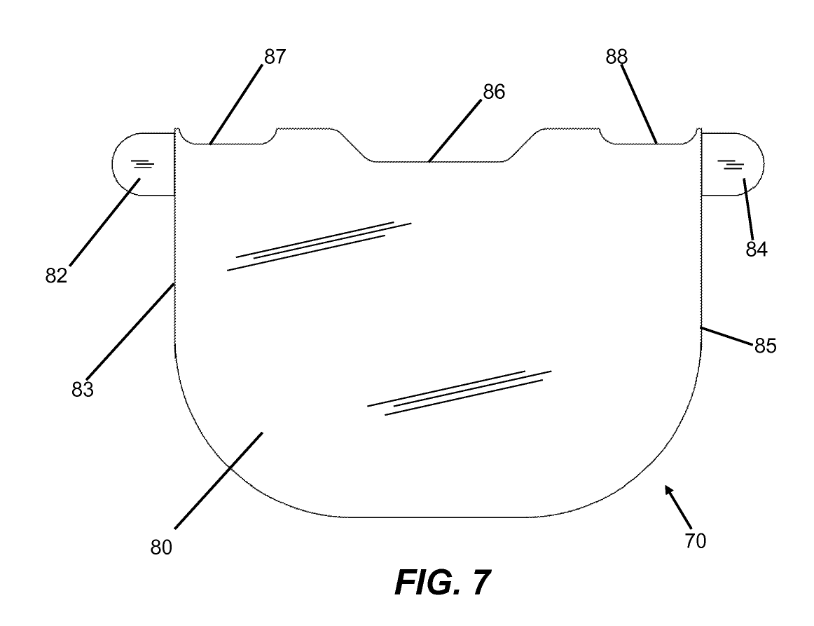

An illustrative configuration of the baffles 70 is best shown in FIG. 7. Baffles 70 include a planar body portion 80 having first and second mounting tabs 82 and 84 extending from opposite ends 83 and 85, respectively, of body portion 80. An inner edge of body portion 80 includes a central recess 86 and first and second side recesses 87 and 88. The recesses 86, 87, and 88 are formed to fit over bulb 16 and coupling portions 66, and 68, respectively. Recess 86 provides a gap between bulb 16 and the body portion 80 of baffle 70 sized to reduce the likelihood of arching between the bulb 16 and the baffle 70.

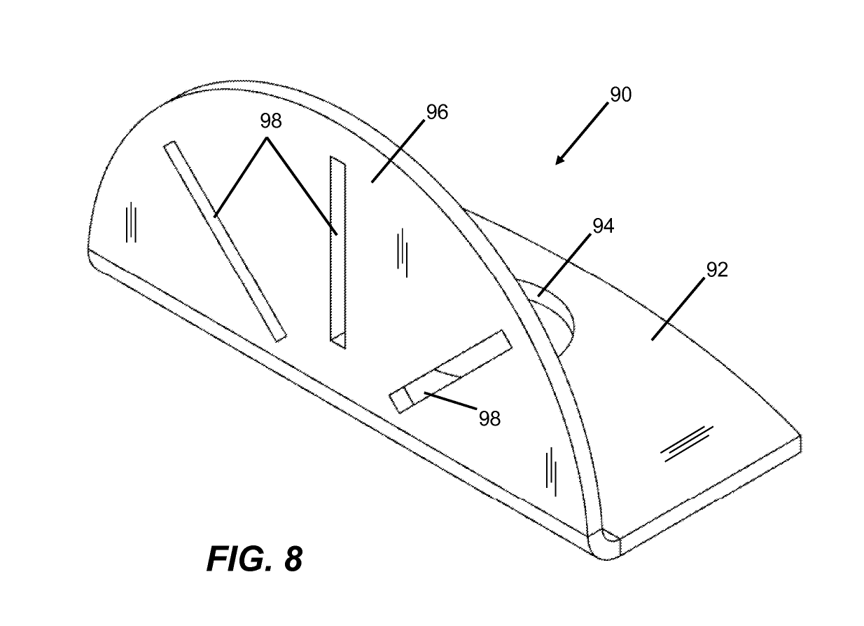

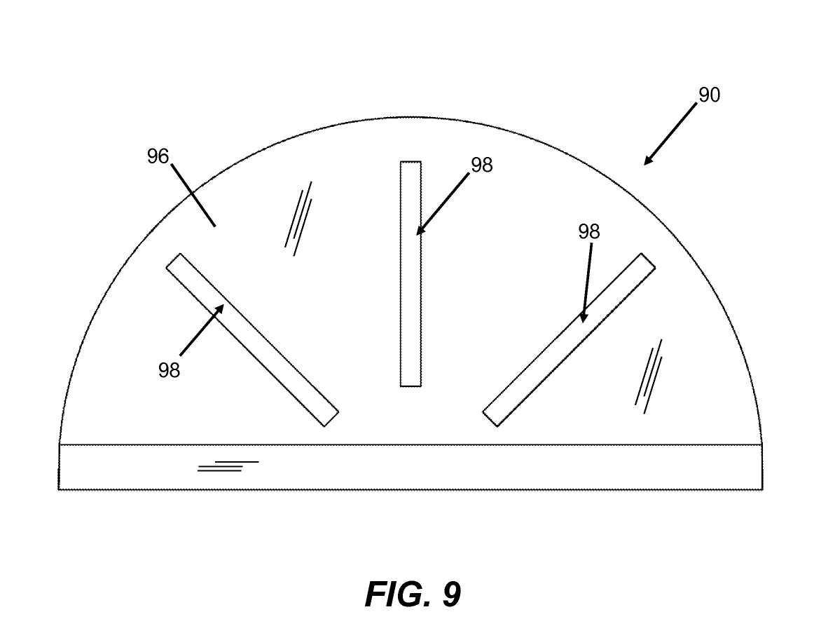

In the illustrated embodiment, the plurality of baffles 70 are coupled to the emitter 12 by a pair of mounting brackets 90 best shown in FIGS. 8 and 9. The mounting brackets 90 include a base portion 92 having an aperture 94 formed therein. The aperture 94 is configured to receive a fastener therethrough to secure the mounting plate 90 to the body portion 60 of emitter 12 as best shown in FIG. 3.

Mounting brackets 90 include a mounting portion 96 extending upwardly from base 92. Mounting portion 96 includes a plurality of elongated apertures 98 configured to receive tabs 82 and 84 of baffles 70 to secure the baffles 70 to the mounting brackets 90. As best shown in FIG. 3, the tabs 82 and 84 fit within the elongated apertures 98 of mounting brackets 90 to hold the baffles 70 in the desired orientation. The width of tabs 82 and 84 and length of slots 98 prevent rotational movement of the baffles 70 relative to bottom surface 64 of puck 14.

Baffles 70 are formed from a suitable conductive material such as aluminum, for example. Baffles 70 are grounded so when the RF field from puck 14 strikes the baffles 70, RF energy is dissipated or absorbed by baffles 70. Baffles 70 allow energy from the incident radiated RF electromagnetic waves to be conducted to ground as an electrical current, thus minimizing the radiated RF electromagnetic waves that leave the fixture. Therefore, baffles 70 provide RF shields located between the emitter 12 and window 20 to reduce RF interference emitted from lighting apparatus 10.

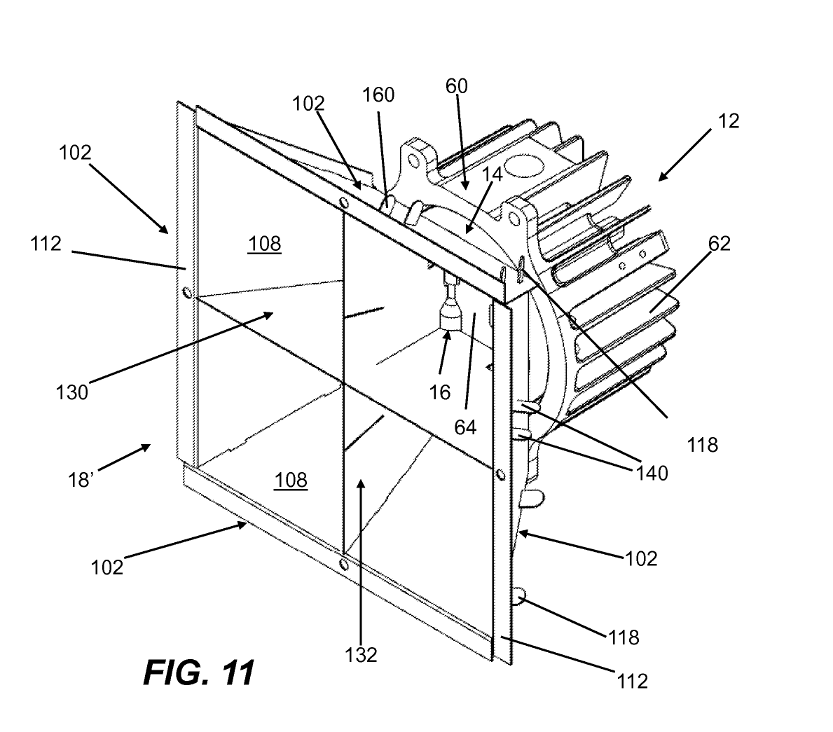

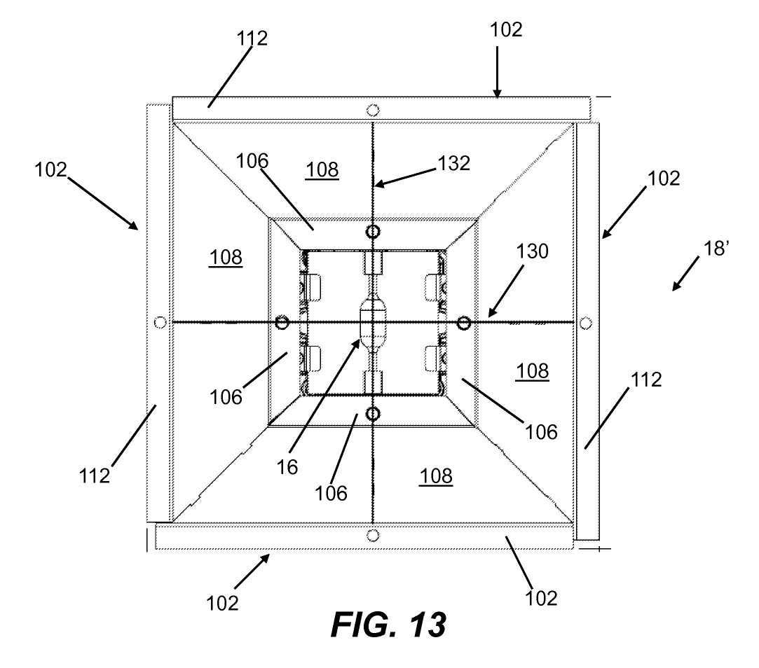

Another embodiment of the present disclosure is illustrated in FIGS. 10-17. Components labeled with the same numbers as FIGS. 1-9 perform the same or similar function in this illustrated embodiment. In the embodiment of FIGS. 10-17, a plurality of RF absorption shields or baffles 130, 132 are coupled to reflector 18′ inside reflector housing 22 as best shown in FIGS. 11 and 13. Reflector 18′ is coupled to body portion 60 of emitter 12. Reflector 18′ illustratively includes four outer panels 102 which are interconnected to form an outer periphery of the reflector 18′.

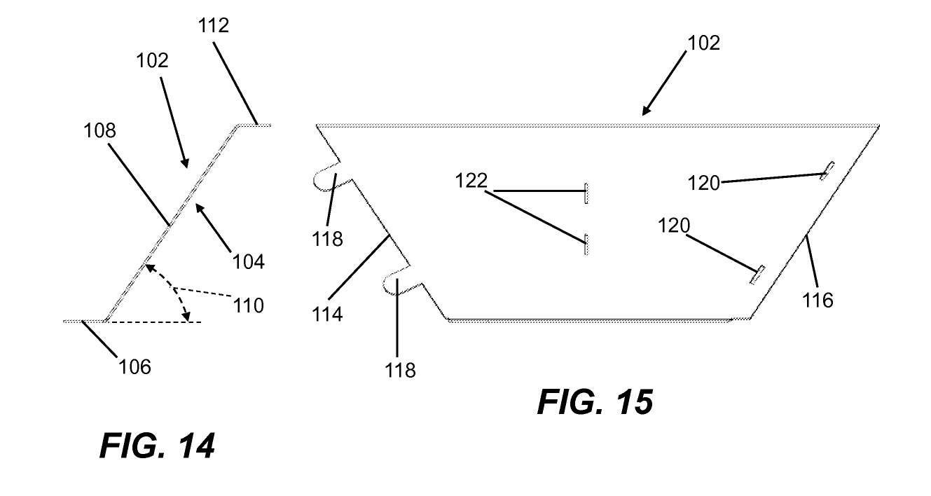

Outer panels 102 are best shown in FIGS. 14 and 15. Each outer panel 102 includes a body portion 104 having a bottom flange 106 and a central portion 108 extending upwardly at about a 45° angle relative to the bottom surface 64 of puck 14 as illustrated by angle 110 of FIG. 14. A top flange 112 is located at an opposite end of center portion 108 of each panel 102.

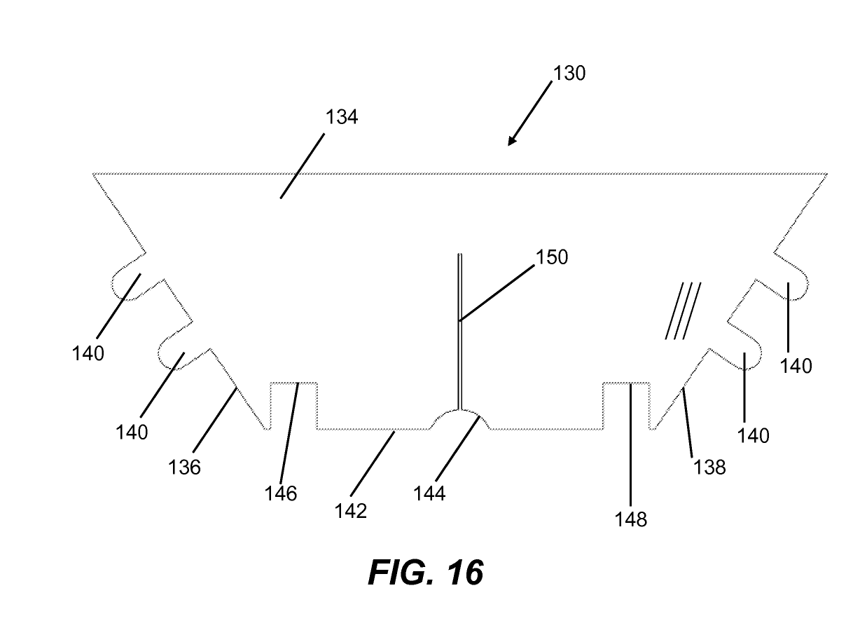

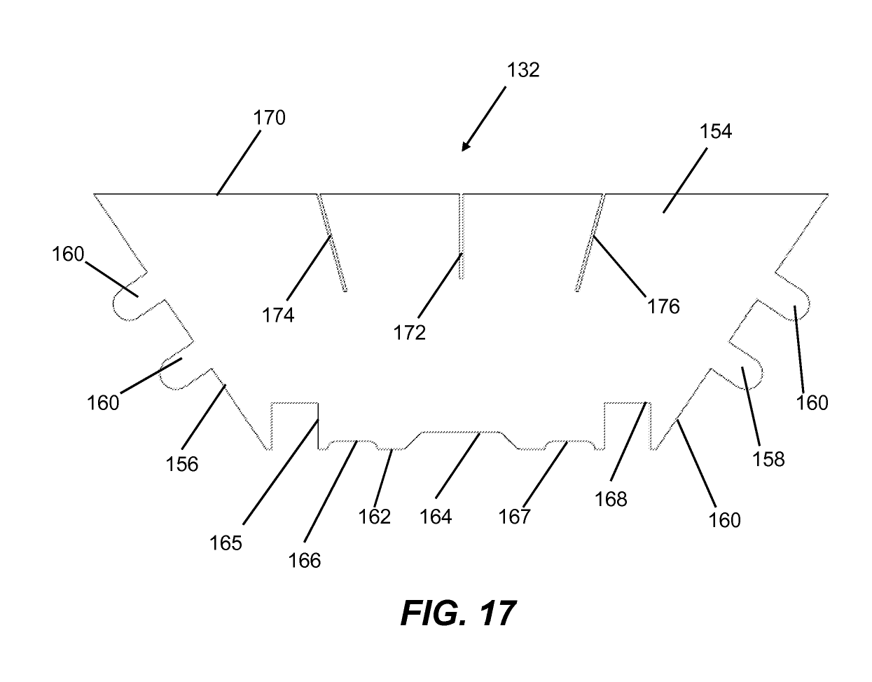

Each outer panel 102 includes ends 114 and 116 which are aligned at 45° angles as shown in FIG. 15. A pair of mounting tabs 118 extend away from end 114 of outer panels 102. The opposite end 116 of outer panels 102 are formed to include slots 120 configured to receive tabs 118 of an adjacent panel 102 to form the outer periphery of reflector 18′. Each of the outer panels 102 further includes slots 122 to connect the outer panels 102 to inner baffles 130 and 132 as best shown in FIGS. 16 and 17.

Inner baffle 130 best shown in FIG. 16 includes a planar body portion 134 having opposite ends 136 and 138. Mounting tabs 140 extend away from opposite ends 136 and 138 of body portion 134. A bottom edge 142 is formed to include notched portions or recesses 144, 146 and 148. Recess 144 is contoured so that body portion 134 is spaced apart from bulb 16 by a gap sized to reduce the likelihood of arching. Recesses 146 and 148 are configured to be located over fasteners coupled to body portion 60 of emitter 12 Inner baffle 130 further includes an elongated slot 150 extending upwardly from recess 144.

A second inner baffle 132 is best shown in FIG. 17. Inner baffle 132 includes a planar body portion 154 having first and second ends 156 and 158. Tabs 160 extend away from the first and second ends 156 and 158 of body portion 154. A bottom 162 of body portion 154 includes a central notched portion or recess 164, and additional notched portions or recesses 165, 166, 167, and 168. Central recess 164 and recesses 166 and 167 fit over bulb 16 and coupling portions 66 and 68, respectively. Body portion 154 is spaced apart from bulb 16 by recess 164 which defines a gap sized to reduce the likelihood of arching. Recesses 165 and 168 fit over fasteners coupled to body portion 60 of emitter 12. Inner baffle 132 includes a top edge 170 having a downwardly extending central slot 172 and first and second side slots 174 and 176. Side slots 174 and 176 are not necessary for embodiments with only two inner baffles 130 and 132 such as shown in FIGS. 10-17.

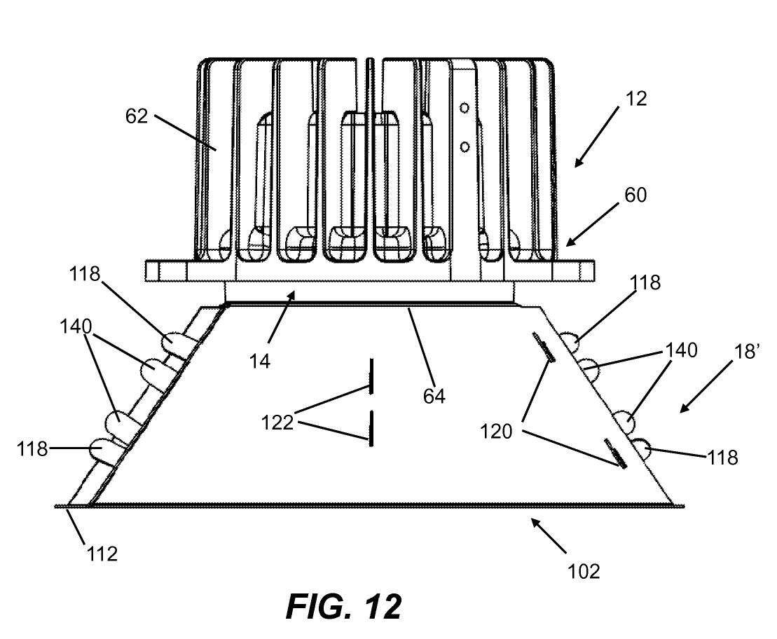

As best shown in FIG. 13, baffles 130 and 132 intersect directly over bulb 16. The slot 150 of baffle 130 is inserted over baffle 132 so that baffle 130 is located within slot 172 of baffle 132 to interconnect inner baffles 130 and 132 as shown in FIGS. 10, 11 and 13. Tabs 140 of baffle 130 and tabs 160 of baffle 132 extend through slots 122 in outer panels 102 as best shown in FIGS. 11 and 12 to secure the inner baffles 130 and 132 to the outer panels 102. Reflector 18′ is formed by central portions 108 of outer panels 102 which are aligned at a 45° angle relative to the bottom surface 64 of puck 14. The baffles 130 and 132 are aligned perpendicular to the bulb 16 and the bottom surface 64 of puck 14 to minimize interference of the baffles 130 and 132 with light emitted from bulb 16.

Baffles 130 and 132 and outer panels 102 are formed from a suitable conductive material, such as aluminum, to absorb RF energy emitted from emitter 12 that strikes the baffles 130 and 132. Panels 102 and baffles 130 and 132 are grounded so that RF interference emitted from the lighting apparatus 10 is reduced.

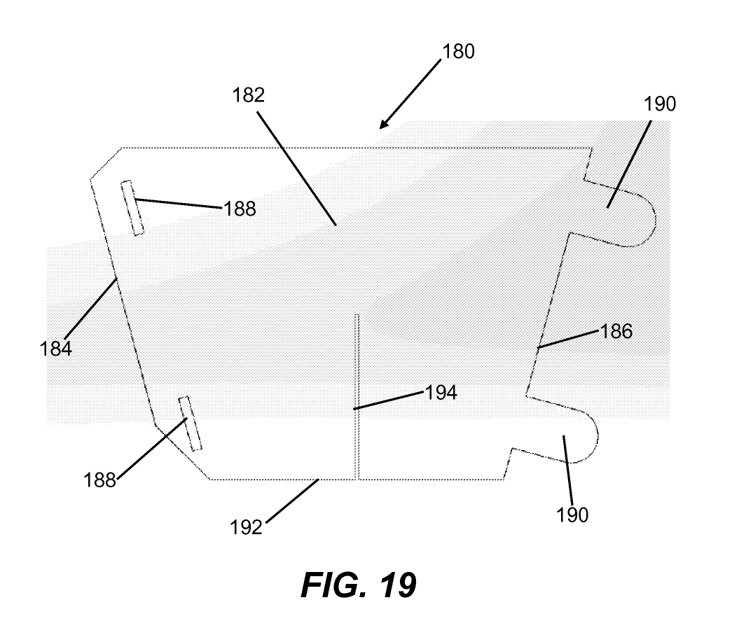

Another embodiment of the present invention is illustrated in FIGS. 18 and 19. In this illustrated embodiment, additional inner RF shields or baffles 180 are coupled to inner baffles 130 and 132. The additional inner baffles 180 are best shown in FIG. 19. Baffles 180 each include a planar body portion 182 having first and second ends 184 and 186. Body portion 182 is formed to include apertures 188 located near end 184. Tabs 190 are configured to extend from end 186 of baffles 180. Body portion 182 includes a bottom edge 192 having an upwardly extending elongated slot 194. Slots 194 of baffles 180 are positioned over baffles 130 and 132. In an illustrated embodiment, slots 194 are aligned with slots 174 and 176 of baffle 132 so that inner baffles 180 are aligned at an angle of about 60° relative to bottom surface 64 of puck 14. However, planar body portions 182 of baffles 180 are aligned perpendicular to an outer surface of bulb 16 to minimize the blocking effect of baffles 180 on light emitted by the bulb 16. Baffle 130 may also have slots 174 and 176. Tabs 190 from one inner baffle 180 are located within slots 188 of an adjacent inner baffle 180 to form an interconnected matrix of RF absorption baffles 180 best shown in FIG. 17.

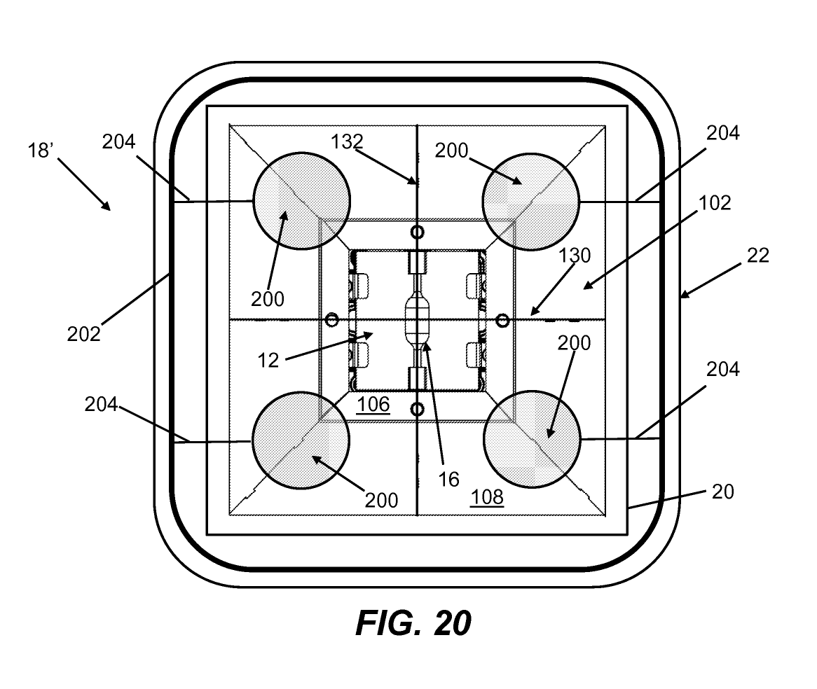

Another embodiment of the present disclosure is illustrated in FIG. 20. FIG. 20 is similar to FIG. 13. However, the housing 22 of reflector 18′ is shown in FIG. 20. As discussed above, window 20 is coupled to the bottom portion 24 of housing 22 so that the window 20 is located over the opening 26 in reflector 18′. The use of RF shields or baffles 70, 130, 132, and 180, for example, reduces the RF field emitted from lighting apparatus 10 without fully covering the window 20 with a conductive screen, mesh, film or coating. In certain illustrated embodiments, no conductive mesh, screen, film or coating is used on the window 20. In other embodiments, the window 20 is provided with conductive portions 200 which cover less than the entire window 20. Four such conductive portions 200 are illustrated in FIG. 20. In a further embodiment, the window 20 is fully covered with a conductive portion 200. However, the conductive portion 200 has a higher light transmission factor (such as a mesh with fewer openings per inch and/or finer wires) than conductive material used in conventional plasma lights without the RF shielding baffles of the present disclosure. For example, if a conventional light fixture uses a conductive mesh having an 80 OPI (openings per inch) rating, the same light fixture including the RF baffles 70, 130, 132, and/or 180 of the present disclosure may use a conductive mesh having a rating of 50 OPI. Therefore, these embodiments achieve similar RF shielding with a higher light output than is achieved through the use of the lower light transmission RF shielding mesh alone.

In illustrated embodiments, the baffles 70, 130, 132, and 180 substantially reduce the RF field emitted from the lighting apparatus 10. However, in the FIG. 20 embodiment, certain selected portions of the window 20 are covered with the conductive mesh, screen, film or coating (referred to as conductive portions 200) to further reduce RF emissions from targeted areas of the reflector 18′. In embodiments where the conductive material 200 is used, the conductive material 200 is electrically coupled to an outer conductive path 202 extending around the periphery of reflector 18′. Illustratively, the conductive material portions 200 are connected to outer conductive path 202 by conductive portions 204. The conductive path 202 is grounded to provide a ground connection to conductive material 200 on window 20.

Illustratively, the reflectors 18 and 18′ containing RF shielding baffles 70, 130, 132 and/or 180 are analyzed to determine if any portions of the reflector are emitting higher than desired RF fields. If so, the conductive material 200 is selectively placed on targeted portions of the window 20. Therefore, the combined coverage area of the conductive portions 200 is less than an overall area of the entire window 20 to increase the amount of light emitted through the window 20 compared to windows that are fully covered with a conductive material.

While this disclosure has been described as having exemplary designs and embodiments, the present system may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

1. A light emitting plasma lighting apparatus driven by a driver which generates a radio frequency (RF) output signal, the apparatus comprising:
a reflector housing having first and second openings;
an emitter including a body portion coupled to the first opening of the reflector housing, the body portion of the emitter having an opening therein, the emitter also including a puck located in the opening of the body portion, the puck having an exposed bottom surface and a plasma bulb coupled to the bottom surface of the puck, the puck being coupled to the driver to receive the RF output signal and provide a concentrated RF field so that light is emitted from an outer surface of the plasma bulb and an RF field is emitted from the bottom surface of the puck;
a reflector located in the reflector housing to direct light emitted from the plasma bulb through the second opening;
a window positioned over the second opening of the reflector housing spaced apart from the plasma bulb so that light emitted from the plasma bulb passes through the window; and
at least one conductive RF shielding baffle located in the reflector housing between the emitter and the window, the at least one RF shielding baffle including a planar body portion aligned generally perpendicular to the outer surface of the plasma bulb to minimize interference with light emitted from the plasma bulb, and the at least on RF shielding baffle being grounded to absorb a portion of the RF field emitted by puck.

2. The apparatus of claim 1, wherein a plurality of RF shielding baffles are coupled to the body portion of the emitter, the planar body portion of each of the plurality of RF shielding baffles being aligned generally perpendicular to the outer surface of the plasma bulb.

3. The apparatus of claim 2, wherein at least one of the planar body portions of the plurality of RF shielding baffles is aligned perpendicular to the bottom surface of the puck.

4. The apparatus of claim 2, further comprising first and second mounting plates coupled to the body portion of the emitter on opposite sides of the puck, and wherein the plurality of RF shielding baffles are coupled to the first and second mounting plates to hold the plurality of RF shielding baffles in a fixed position relative to the plasma bulb.

5. The apparatus of claim 4, wherein each RF shielding baffle includes first and second mounting tabs located at opposite ends of the planar body portion, and wherein the first and second mounting plates each include a plurality of elongated slots configured to receive first and second mounting tabs of the RF shielding baffles, respectively, to secure the plurality of RF shielding baffles to the first and second mounting plates in the fixed position relative to the plasma bulb.

6. The apparatus of claim 2, wherein the plurality of RF shielding baffles cooperate to define a barrier located between the bottom surface of the puck and the window.

7. The apparatus of claim 2, wherein the plurality of RF shielding baffles include a center baffle aligned perpendicular to the bottom surface of the puck and first and second side baffles located on opposite sides of the center baffle, the first and second side baffles being aligned at a 45° angle relative to the bottom surface of the puck.

8. The apparatus of claim 1, wherein the planar body portion of the at least one RF shielding baffle includes an inner edge having a contoured recess shaped to provide a gap between the RF shielding baffle and the outer surface of the plasma bulb.

9. The apparatus of claim 1, further comprising a conductive material located on the window, the conductive material being grounded to further absorb portions of the RF field emitted by the puck.

10. The apparatus of claim 9, wherein the conductive material covers a selected portion of the window, the selected portion being smaller than an overall area of the window.

11. The apparatus of claim 10, wherein the conductive material covers a plurality of spaced apart portions of the window.

12. The apparatus of claim 10, wherein the conductive material is one of a conductive mesh, a conductive screen, a conductive film and a conductive coating.

13. The apparatus of claim 1, wherein the at least one conductive RF shielding baffle is coupled to the reflector.

14. The apparatus of claim 13, wherein first and second RF shielding baffles are coupled to the reflector, the planar body portions of the first and second RF shielding baffles being aligned perpendicular to the bottom surface of the puck, and the first and second RF shielding baffles intersecting at a point aligned with the plasma bulb.

15. The apparatus of claim 14, wherein the first and second RF shielding baffles each include mounting tabs extending away from opposite end edges of the planar body portion, the mounting tabs extending through slots formed in the reflector to secure the first and second RF shielding baffles to the reflector.

16. The apparatus of claim 14, wherein the first and second RF shielding baffles each include an inner edge formed to include a recess to provide a gap between the first and second RF shielding baffles and the plasma bulb.

17. The apparatus of claim 14, wherein the first RF shielding baffle includes a first elongated slot extending from the inner edge and the second RF shielding baffle includes a second elongated slot extending from an outer edge, the first and second elongated slots being configured to receive portions of the second and first RF shielding baffles, respectively, to connect the first and second RF shielding baffles together.

18. The apparatus of claim 14, further comprising a plurality of inner baffles coupled to the first and second RF shielding baffles.

19. The apparatus of claim 18, wherein the plurality of inner baffles each include a planar body portion having a first end and a second end, at least one tab extending away from the first end of the inner baffles, and at least one slot being formed adjacent the second end of the inner baffles, the at least one slot being configured to receive the at least one tab of an adjacent inner baffle to connect the inner baffles together at the intersecting point.

20. The apparatus of claim 18, wherein each of the plurality of inner baffles includes an inner edge having an elongated slot formed therein, the elongated slot of the inner baffle being positioned over one of the first and second RF shielding baffles to couple the inner baffles to the first and second baffles.

21. The apparatus of claim 18, wherein the plurality of inner baffles each include a planar body portion aligned generally perpendicular to the outer surface of the plasma bulb.

22. The apparatus of claim 1, wherein the at least one RF shielding baffle is coupled to the emitter.

23. A light emitting plasma emitter apparatus comprising:
a metal body portion defining an opening therein;
a puck located in the opening of the body portion, the puck having an exposed bottom surface and a plasma bulb coupled to the bottom surface of the puck, the puck being configured to provide a concentrated RF field from a RF signal received from a driver so that light is emitted from an outer surface of the plasma bulb and an RF field is emitted from the bottom surface of the puck; and
at least one conductive RF shielding baffle coupled to the body portion over the bottom surface of the puck, the RF shielding baffle including a planar body portion aligned generally perpendicular to the outer surface of the plasma bulb, and wherein the RF shielding baffle is grounded to absorb a portion of the RF field emitted from the bottom surface of the puck.

24. The apparatus of claim 23, wherein a plurality of RF shielding baffles are coupled to the body portion, the planar body portion of each of the plurality of RF shielding baffles being aligned generally perpendicular to the outer surface of the plasma bulb

25. The apparatus of claim 24, further comprising first and second mounting plates coupled to the body portion of the emitter on opposite sides of the puck, and wherein the plurality of RF shielding baffles are coupled to the first and second mounting plates to hold the plurality of RF shielding baffles in a fixed position relative to the plasma bulb.

26. The apparatus of claim 25, wherein the planar body portion of the at least one RF shielding baffle includes an inner edge having a contoured recess shaped to provide a gap between the RF shielding baffle and the outer surface of the plasma bulb.

27. A light emitting plasma lighting apparatus driven by a driver which generates a radio frequency (RF) output signal, the apparatus comprising:
a reflector housing having first and second openings;
an emitter coupled to the first opening of the reflector housing, the emitter including a puck having a bottom surface and a plasma bulb coupled to the bottom surface of the puck, the puck being coupled to the driver to receive the RF output signal so that light emitted from an outer surface of the plasma bulb and an RF field is emitted from the puck;
a reflector located in the reflector housing to direct light emitted by the plasma bulb through the second opening;
a window positioned over the second opening of the reflector housing spaced apart from the plasma bulb so that light emitted by the plasma bulb passes through the window; and
at least one conductive portion covering at least one selected portion of the window, the at least one selected portion having a combined area less than an overall area of the window, the at least one conductive portion being grounded to absorb portions of the RF field emitted by the puck.

28. The apparatus of claim 27, wherein the at least one conductive portion is formed by one of a conductive mesh, a conductive screen, a conductive film and a conductive coating.

29. The apparatus of claim 27, further comprising at least one conductive RF shielding baffle located in the reflector housing between the emitter and the window, the at least one RF shielding baffle including a planar body portion aligned generally perpendicular to the outer surface of the plasma bulb to minimize interference with light emitted from the plasma bulb, and the at least on RF shielding baffle being grounded to absorb a portion of the RF field emitted by puck.

30. The apparatus of claim 29, wherein a plurality of RF shielding baffles are coupled to the emitter, the planar body portion of each of the plurality of RF shielding baffles being aligned generally perpendicular to the outer surface of the plasma bulb

31. The apparatus of claim 30, further comprising first and second mounting plates coupled to the emitter on opposite sides of the puck, and wherein the plurality of RF shielding baffles are coupled to the first and second mounting plates to hold the plurality of RF shielding baffles in a fixed position relative to the plasma bulb.

32. The apparatus of claim 29, wherein the at least one conductive RF shielding baffle is coupled to the reflector.

33. The apparatus of claim 32, wherein first and second RF shielding baffles are coupled to the reflector, the planar body portions of the first and second RF shielding baffles being aligned perpendicular to the bottom surface of the puck, and the first and second RF shielding baffles intersecting at a point aligned with the plasma bulb.

34. The apparatus of claim 33, further comprising a plurality of inner baffles coupled to the first and second RF shielding baffles, the plurality of inner baffles each including a planar body portion aligned generally perpendicular to the outer surface of the plasma bulb.
